(19) United States
(12) Patent Application Publication
(10) Pub. No.: US 2015/0035319 A1
(43) Pub. Date: Feb. 5, 2015

(54) Cooling Line Grommet Sealing Passage Through Multiple Vehicle Panels

(71) Applicant: Ford Global Technologies, LLC, Dearborn, MI (US)

(72) Inventors: David D. Fabricatore, Canton, MI (US); Emin Oker, Ann Arbor, MI (US); Elizabeth Louise Dearie, Rochester Hills, MI (US)

(73) Assignee: Ford Global Technologies, LLC, Dearborn, MI (US)

(21) Appl. No.: 13/956,613

(22) Filed: Aug. 1, 2013

(51) Int. Cl. F16J 15/02; B60R 16/08; F28F 9/007; B62D 25/20

(52) U.S. Cl. CPC F16J 15/02; B62D 25/20; B60R 16/08; F28F 9/007
USPC 296/193.07

(57) ABSTRACT

A grommet assembly for sealing an opening through a floor pan and a reinforcement panel that are spaced apart is disclosed. The grommet assembly also seals around cooling lines that pass through the grommet assembly. The grommet assembly defines hollow sealing legs having extended and inverted positions in which the cooling lines are sealed when the hollow sealing legs are in the inverted position. The grommet assembly seals on the floor pan and is attached to the reinforcement panel. A mounting bracket for the grommet is disclosed having recessed and slotted apertures to aid in receiving the mounting post and aligning the grommet in the opening.

### BACKGROUND

In automotive applications, it may be important to provide a sealing mechanism for pipes and cables that pass between the vehicle cabin compartment and the outside. The primary goal of such a sealing mechanism is to keep water and other contaminants from entering the cabin compartment. The sealing mechanism may also reduce noise and prevent airflow into or out of the cabin compartment.

### SUMMARY

A vehicle is disclosed including a floor pan and a reinforcement panel spaced away from the floor pan, and a cooling line that extends through the floor pan and reinforcement panel. A mounting bracket defines an opening and includes a recessed portion defining at least one slotted aperture for receiving at least one mounting post attached to the reinforcement panel. A grommet extends through the opening in the mounting bracket and includes a sealing ring sealed against the floor pan and a hollow sealing leg having an extended position in which the hollow sealing leg extends away from the body and an inverted position in which the hollow sealing leg is disposed within the body, surrounds the cooling line, and seals against the cooling line. In one embodiment, the floor pan includes a surface facing the reinforcement panel and the sealing ring is sealed against this surface. The hollow sealing leg may include a sealing rib that contacts the cooling line when the hollow sealing leg is in the inverted position. The cooling line may include a ridge to prevent the hollow sealing leg from moving from the inverted position to the extended position.

A vehicle is disclosed that includes a floor pan that partially defines an exterior of the vehicle and a reinforcement panel spaced away from the floor pan that partially defines the interior of the vehicle. At least one mounting post is attached to the reinforcement panel. The vehicle also includes a grommet assembly that further includes a mounting bracket that defines an opening and at least one aperture configured to receive the mounting post and includes a recessed portion defining the aperture. A grommet extends through the opening and attaches to the mounting bracket. The grommet includes a sealing ring for sealing against the floor pan. The grommet assembly further includes a hollow sealing leg having an extended position in which the hollow sealing leg extends away from the grommet toward the interior of the vehicle and an inverted position in which the hollow sealing leg is disposed within the grommet and extends toward the exterior of the vehicle. One or more apertures of the mounting bracket may be slotted. The hollow sealing leg may include a sealing rib disposed on an outside of the hollow sealing leg when the hollow sealing leg is in the extended position and disposed on an inside of the hollow sealing leg when the hollow sealing leg is in the inverted position.

A vehicle is disclosed that includes a floor pan and a reinforcement panel spaced away from the floor pan, at least one mounting post attached to the reinforcement panel, and a grommet assembly attached to the reinforcement panel and sealed against the floor pan. The grommet assembly further comprises a mounting bracket that defines an opening for attaching a grommet and includes a recessed portion defining at least one slotted aperture configured to receive the mounting post. In one embodiment, the floor pan includes a surface facing the reinforcement panel and the sealing ring is sealed against this surface. The grommet assembly may further comprise a hollow sealing leg, having an extended position in which the hollow sealing leg extends away from the grommet assembly and an inverted position in which the hollow sealing leg is disposed within the grommet assembly, wherein the hollow sealing leg is in the inverted position, surrounds a cooling line, and seals against the cooling line when the cooling line extends through the floor pan and the reinforcement panel. The hollow sealing leg may include a sealing rib that contacts the cooling line when the hollow sealing leg is in the inverted position.

### BRIEF DESCRIPTION OF THE DRAWINGS

FIG. 1 is a side view, in cross-section, of a prior art grommet assembly.

FIG. 2 is a side view, in cross-section, of a grommet assembly.

FIGS. 3a and 3b are top and side views respectively of a prior art mounting bracket.

FIGS. 4a and 4B are top and side views respectively of another mounting bracket.

FIGS. 5a and 5B are side views of a hollow sealing leg in an extended position and in an inverted/sealing position respectively.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A typical application may require that a pipe pass through a single layer panel and seal on that single panel. To provide additional structural support, some vehicle applications may add additional panels in parallel. These panels may have a gap between them. There may be applications in which a pipe must pass through these multiple panels. It may then become important that the opening be sealed on at least the outermost panel to prevent contaminants from entering the cabin compartment.

In one possible application, there may be a battery pack that is located in the cabin compartment. The battery pack may require coolant lines that are routed outside of the cabin compartment. This routing may be through an opening in the body structure that may consist of two panels separated by a gap. An added challenge is that installation of the sealing mechanism should be possible from one side of the opening. For example, a person installing the coolant lines and seal should be able to perform the operation entirely from the cabin compartment without having to perform any installation operations outside of the cabin compartment.

A device for sealing the opening in which cooling lines pass through body panels may provide a seal for two different areas. The first area being the actual opening through the body panels through which the cooling lines are routed. The second area being around the coolant lines as they pass through the sealing device. The assembly described applies to the sealing of any conduit, pipe or equivalent that may pass through the body panels of a vehicle and is not limited to cooling lines.

When routing pipes and cables through body panels, the opening may be sealed with a grommet. A grommet may seal the area around the opening and the area around the cable or pipe. A typical opening may pass through a single body panel. For some applications, there may be multiple panels that the pipes must pass through. Additionally, there may be a gap between the body panels. An application of this may be in which cooling lines are routed through a floor pan and in which the floor pan has an additional reinforcement panel spaced a short distance away to provide additional support to the structure. Depending on the application, it may be required to seal the opening of one or more of these panels. The present application involves sealing an opening in which pipes pass through multiple body panels.

To be effective, a sealing device should be installed properly. If the sealing portion is not installed properly, the sealing effectiveness may be compromised. If the sealing component is misaligned with the surface that it must seal on, then the seal may not be effective. In some applications, it may be important that the sealing device be aligned about an opening to ensure a proper seal. An effective sealing mechanism may provide a means of ensuring the proper alignment of the seal.

Another consideration may be the installation of the pipes and grommet into the vehicle. A grommet may require access to all panels or surfaces to be sealed. Consider an opening between the cabin compartment and the underside of a vehicle. Routing a line through such an opening may require manipulation from both sides in order to make the grommet seal properly. Such a requirement increases the complexity and duration of the installation. Requiring access to both sides may increase installation time or may require multiple persons to complete the task, either of which will increase the cost of the operation. A preferred approach may be one in which the lines can be installed from one side without any required manipulation on the other side.

Installation considerations may also favor mounting by fasteners as opposed to a grommet that fits into an opening and secures itself to the panel. Depending on the space available for installation, there may not be enough space for an installer to easily work the grommet into place. However, there may be space to get a tool into the area to tighten a fastener. In the case of multiple panels, it may be difficult to work the grommet into a sealing position on the outermost panel. Fasteners may also hold the grommet in place more securely. The fasteners may also provide a means of aligning the assembly into the proper position.

This disclosure describes possible embodiments of a grommet assembly to provide an effective sealing grommet. The embodiments may effectively seal to a surface of one of the panels and attach to the other panel.

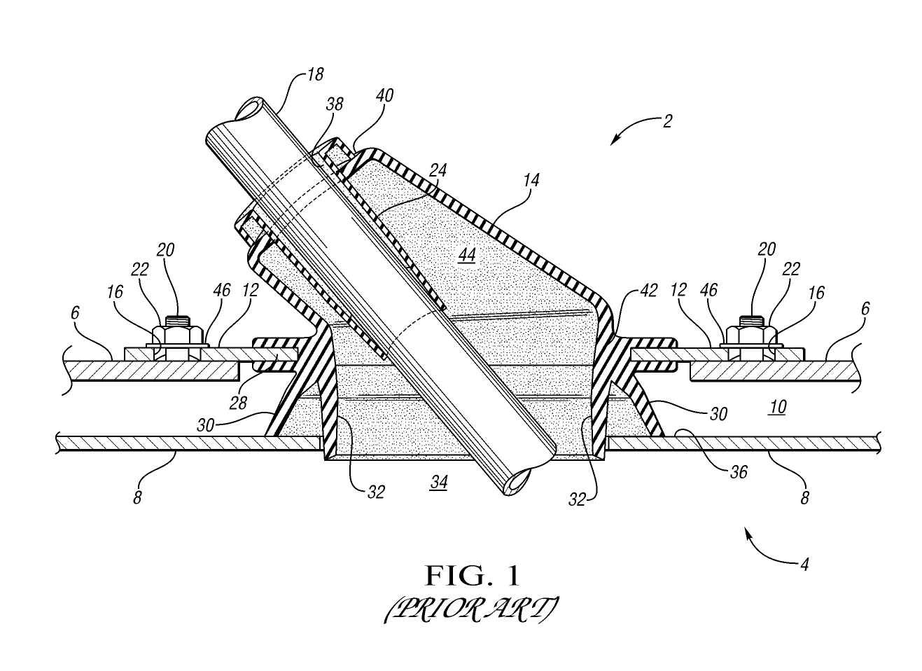

FIG. 1 shows a cross section of a prior art grommet assembly for sealing an opening through two body panels. An application may require that pipes 18 be routed between a cabin compartment 2 and an underside of a vehicle 4. The pipes 18 may be cooling lines, for example. The vehicle structure may consist of a floor pan 8 and a doubler or reinforcement panel 6 such that there is a gap 10 between the floor pan 8 and the reinforcement panel 6. One side of the floor pan 8 may partially define the exterior or underside of the vehicle 4. One side of the reinforcement panel 6 may partially define the interior of the vehicle 2.

The grommet assembly consists of a mounting bracket 12 and a grommet 14. The grommet 14 may be made from rubber or other similar resilient material. The mounting bracket 12 may be constructed of metal or other rigid material. The grommet 14 is designed to attach to the mounting bracket 12. The mounting bracket 12 is attached to the reinforcement panel 6 to hold the entire grommet assembly in place.

The mounting bracket 12 may be attached to the reinforcement panel 6 by mounting posts 20 that are secured to the reinforcement panel 6. The mounting posts 20 are weld studs that are welded to the reinforcement panel 6. The mounting holes 16 of the mounting bracket 12 are aligned with the mounting posts 20. The mounting bracket 12 is attached to the reinforcement panel 6 by a nut 22 that is fitted to the mounting post 20. A washer 46 may be used with the nut 22 depending on the size of the mounting holes 16 and the size of the nut 22 used. The mounting bracket 12 is secured between the nut 22 and the reinforcement panel 6 when the nut 22 is tightened.

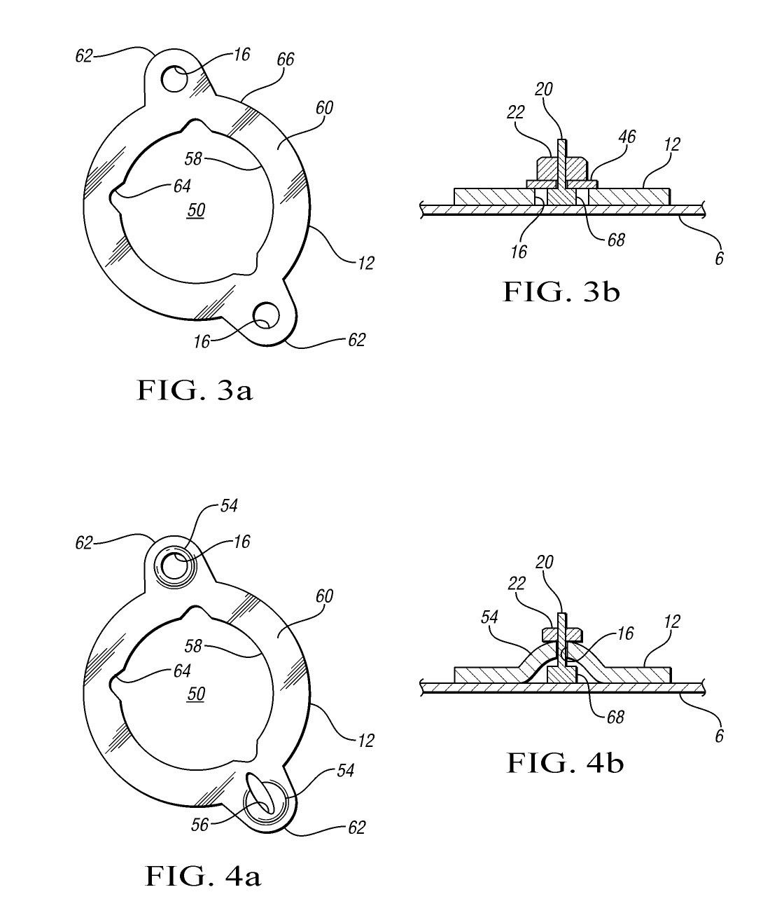

FIG. 3 shows a top and side view of a prior art mounting bracket 12 that is used with the grommet assembly of FIG. 1. FIG. 3(a) depicts a top view of a mounting bracket 12 that has a round annular portion 58 that defines an opening 50 through which the grommet (14 FIG. 1) is fitted. A flange portion 60 is formed around the periphery of the round annular portion 58. The outer periphery 66 of the flange is annular shaped. The size of the outer periphery 66 is such that it is larger than the size of the outer periphery of the reinforcement panel opening. There are one or more notches 64 in the flange portion 60 that may facilitate the installation of the grommet onto the mounting bracket 12. The flange 60 has two tabs 62 that extend outward in a direction opposite the round annular portion 58. The mounting bracket 12 also defines mounting apertures or holes 16 for fastening the mounting bracket 12 to the reinforcement panel 6. The mounting holes 16 are located within the tabs 62.

Referring now to FIG. 3(b), a side view of the prior art mounting bracket 12 is shown. When a mounting post 20 is used, the mounting holes 16 must be large enough to accommodate a weld shoulder 68 of the mounting post 20. To accommodate for manufacturing tolerances, the mounting holes 16 must be larger than the weld shoulders 68 and accommodate for any variation in the distance between mounting posts 20. When the tolerances are correct, the mounting holes 16 surround the weld shoulders 68 of the mounting posts 20 so that the mounting bracket 12 lies flat on the reinforcement panel 6. The mounting bracket 12 may then be secured to the mounting post 20 with a washer 46 and a nut 22. In practice, the diameter and shape of the weld shoulders 68 may vary, so the mounting holes 16 must be large enough to accommodate for the worst case variations. Because of this, the mounting holes may be required to be large to accommodate for the weld shoulder 68 variation as well as tolerances in the distance between the mounting posts.

Referring again to FIG. 1, the grommet 14 is fitted through the mounting bracket 12 and secured to the mounting bracket. The grommet 14 has a bracket seal 42 portion for connecting the grommet 14 to the mounting bracket 12. The bracket seal 42 defines a groove 28 around the periphery of the grommet 14.

The grommet 14 is positioned inside of the opening of the mounting bracket (50 FIG. 3(a)) and secured by inserting the mounting bracket 12 into the groove 28. The shape of the periphery of the grommet 14 is matched to the shape of the opening of the mounting bracket (50 FIG. 3(a)) such that there is a secure fit when the mounting bracket 12 is fitted into the groove 28 of the grommet 14. The groove 28 is sized to the approximate thickness of the mounting bracket 12.

The grommet provides a seal to the floor pan 8. The grommet 14 includes a guide ring 32 and a sealing ring 30, both extending toward the floor pan opening 34. The guide ring 32 extends from the bracket seal 42. The purpose of the guide ring 32 is to align the grommet 14 into place in the floor pan opening 34. As the grommet is inserted through the reinforcement panel opening, the guide ring 32 may contact the floor pan 8. If the guide ring 32 is not aligned properly with the floor pan opening 34, motion in the direction of the floor pan 8 may be resisted. When the guide ring 32 aligns with the floor pan opening 34 such that the guide ring 32 is fully contained by the floor pan opening 34, the grommet may move in the direction of the floor pan 8. This may provide the installer with some indication of whether or not the grommet 14 is being installed properly.

The aligning function is possible when the mounting holes 16 provide sufficient clearance from the mounting posts 20 and weld shoulders (68 FIG. 3(b)) to allow movement of the grommet assembly to aid in guiding the guide ring 32 through the floor pan 8. By aligning the guide ring 32 properly, the sealing ring 30 may be in the proper position to seal effectively. The guide ring 32 may also provide some sealing capability. The mounting holes 16 must be larger than the largest diameter of the mounting post 20 and weld shoulder (68 FIG. 3(b)) plus some tolerance due to the variability of the distance between the mounting posts 20 to allow the mounting bracket 12 to adjust the position as the guide ring 32 is aligned. A disadvantage of this configuration is that since the mounting holes 16 must be large, if the fasteners become loose, the grommet may shift position and not provide an effective seal.

When positioned properly and secured, the sealing ring 30 contacts the floor pan 8 and compresses against the surface facing the reinforcement panel 36 creating a seal as the grommet 14 is inserted toward the floor pan 8. The outer sealing ring 30 extends from the bracket seal 42 at some angle from the guide ring 32 and in the direction of the floor pan 8. The diameter of the sealing ring 30 is greater than the diameter of the floor pan opening 34. The length of the sealing ring 30 is such that when the grommet assembly is fastened, the sealing ring 30 may flex due to contact with the surface facing the reinforcement panel 36. When the fasteners 22 are tightened, the force on the sealing ring 30 creates a seal against the surface facing the reinforcement panel 36.

Problems may arise in the above prior art arrangement when the grommet assembly of FIG. 1 with the guide ring 32 is coupled with the mounting bracket of FIG. 3. With this system, the tolerances may be such that the guide ring 32 may be misaligned. During installation, it is possible that the guide ring 32 may contact the inner surface of the floor pan 36 instead of fitting through the floor pan opening 34. When the mounting bracket 12 is tightened, the guide ring 32 deformation may prevent the sealing ring 30 from making proper contact with the floor pan surface 8. An installer may not be able to detect this situation as the resilient material may not provide sufficient resistance to indicate a problem. When this occurs, the grommet will not seal properly and contaminants may enter the gap.

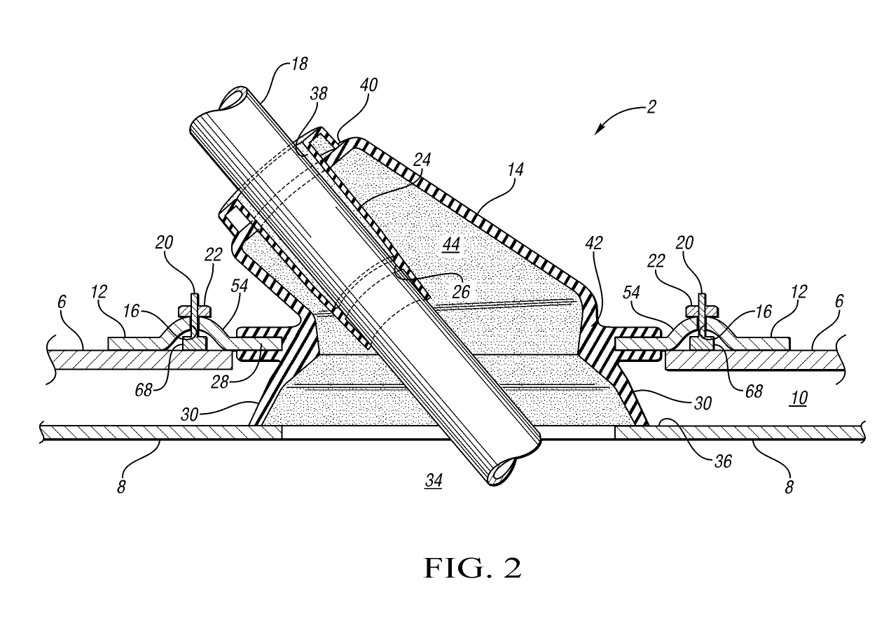

FIG. 2 depicts an improved grommet assembly that lacks the guide ring (32 FIG. 1) of the prior art. The above description for FIG. 1 applies except for any references to the guide ring (32 FIG. 1). In addition, the mounting bracket configuration shown in FIG. 4 is used. The sealing ring 30 has a diameter that is larger than the diameter of the floor pan opening 34. When the grommet assembly mounting holes 16 are aligned to the mounting posts 20, the sealing ring 30 should come to rest on the inner surface 36 of the floor pan 8. As the mounting bracket 12 is tightened, the sealing ring 30 will be pressed against the inner surface 36 of the floor pan 8.

When the prior art guide ring (32 FIG. 1) is removed, a different means of aligning the seal may be desirable. An alternate mounting bracket 12 design is shown in FIG. 4. As shown in FIG. 4(b), the mounting bracket 12 is altered such that the area around the mounting holes or apertures 16 is recessed or cup-shaped 54. This allows the mounting bracket 12 to fit over the weld shoulder 68 of the mounting post 20, instead of having to fit an opening around the weld shoulder 68. This allows for a smaller mounting aperture or hole 16 to be used. To compensate for differences in the distance between the mounting posts 20, one of the mounting apertures 56 may be slotted, as shown in FIG. 4(a). The non-slotted mounting aperture 16 may be first aligned with a mounting post 20. Once a mounting post 20 is inserted into the non-slotted mounting aperture 16, the mounting bracket 12 may be rotated until the slotted mounting aperture 56 and the other mounting post 20 are aligned. Any variation in the distance between the mounting posts 20 may be compensated for by the slot 56. The mounting holes 16 are no longer required to accommodate for the variation in the weld shoulders 68. The weld shoulder 68 variations are accommodated by the recessed structure 54 around the mounting hole 16. The recess 54 can accommodate for worst case weld shoulder 68 variation without affecting the alignment of the grommet assembly.

Using the mounting bracket 12 of FIG. 4, the mounting posts 20 may provide a more predictable position for the grommet assembly within some tolerances. The non-slotted mounting hole 16 provides a fixed mounting point. The slotted mounting hole 56 allows for variation in the distance between the mounting posts 20. The non-slotted mounting hole 16 may be just large enough to receive the mounting posts 20. Since there is no guide ring (32 FIG. 1), there is less material that can be become misaligned. The improved grommet assembly of FIG. 2 effectively moves the alignment function to the mounting bracket instead of the guide ring (32 FIG. 1). This facilitates easier and more reliable installation of the grommet assembly. In addition, the guide ring (32 FIG. 1) protrudes through the floor pan opening 34 and is exposed to possible damage from objects under the vehicle.

The prior art mounting bracket 12 of FIG. 3 relies on the guide ring (32 FIG. 1) to position the grommet assembly properly. Using the mounting bracket 12 of FIG. 3 without the guide ring 32 may cause improper positioning of the sealing ring. Since each of the mounting holes 16 are larger than the mounting post weld shoulders 68, the final position of the mounting bracket 12 may vary considerably. The mounting holes (16 FIG. 3) must be large enough to allow positioning of the assembly due to the varying distance between the two mounting posts 20 and the varying size of the weld shoulders 68. The net effect is that without the guide ring 32, the position of the sealing ring 30 may be less predictable. Depending on how the tolerances stack up, the mounting bracket 12 could be placed in a position where the sealing ring 32 does not completely cover the opening. The mounting holes (16, 56) of FIG. 4 allow less variability and may reduce the chances of the sealing ring 32 being improperly positioned.

Referring again to FIG. 2, the ease of installation is improved when the opening of the reinforcement panel 6 is larger than the opening of the floor pan 8. This allows the sealing ring 30 to pass through the reinforcement panel 6 opening without having to be deformed. The sealing ring 30 may pass through and contact the surface facing the reinforcement panel 36 of the floor pan 8. The grommet assembly may still be effective if the sizes of the openings are the same. However, installation is complicated as there may need to be some manipulation of the sealing ring 30 to get past the opening of reinforcement panel 6.

The grommet 14 may have a one or more hollow sealing legs 24 that allow one or more pipes 18 to pass through the grommet 14. The hollow sealing leg 24 is on the opposite side of the bracket seal 42 as the sealing ring 30. The grommet 14 extends from the bracket seal 42 in a direction opposite the floor pan 8. The grommet 14 forms a cavity 44 that may contain the inverted hollow sealing legs 24. The grommet 14 defines an end surface 40 where the hollow sealing legs 24 may be formed or attached. The end surface 40 may be flat and may provide enough space for one or more hollow sealing legs 24. The hollow sealing legs 24 are attached to the end surface 40 and extend from this end surface 40. The hollow sealing legs 24 may be at some angle from the body panels (6 and 8) such that the pipes 18 are not required to pass perpendicularly through the floor pan 8 and reinforcement panel 6.

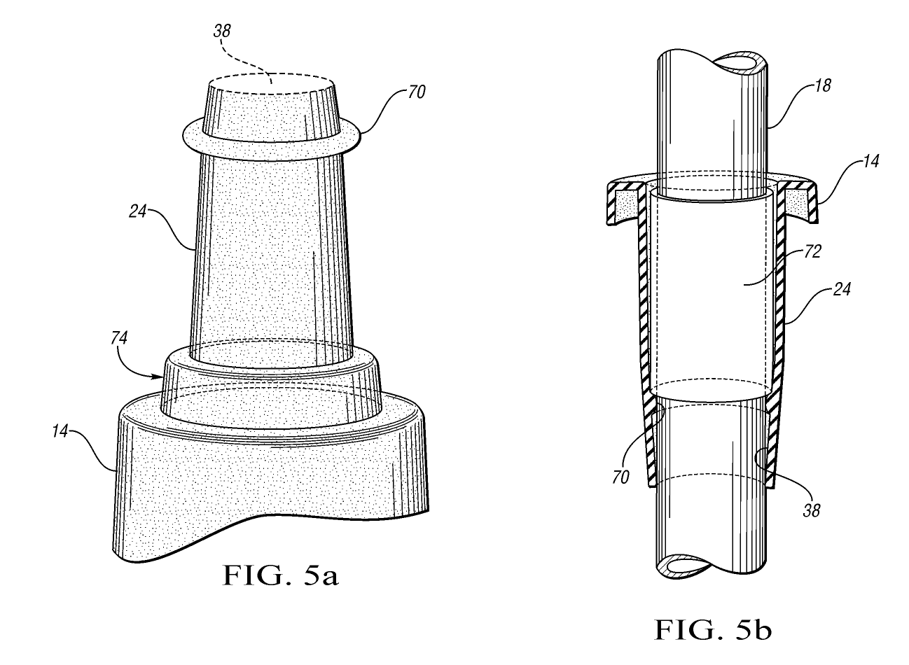

Referring to FIG. 5, the hollow sealing leg 40 may have a base diameter 74 near the end surface (40 FIG. 2) that is larger than the diameter of the pipe 18. At a distal end of the hollow sealing leg 24 there is an opening 38 that is approximately the diameter of the pipe 18. The opening 38 allows the pipe 18 to pass through the grommet assembly. Near the opening 38 may be a sealing rib 70 that extends around the perimeter of the hollow sealing leg 24. The sealing rib 70 may be located a distance from the opening 38 and may be rounded. The sealing rib 70 may be an area that has a thicker layer of resilient material than the adjacent areas. In the extended position, the sealing rib 70 may not appear to contact the pipe 18, that is, the sealing rib 70 is on the outside of the hollow sealing leg 24. The larger base diameter 74 of the hollow sealing leg 24 allows the hollow sealing leg 24 to be inverted as shown in FIG. 5b. When inverted, the thicker material of the sealing rib 70 provides a seal around the pipe 18. In the inverted position, the sealing rib 70 is on the inside of the hollow sealing leg 24.

A pipe 18 may be inserted into the hollow sealing leg 24 while it is in the extended position. The hollow sealing leg opening 38 may be appropriately sized so that when the pipe 18 is inserted the hollow sealing leg opening 38 stretches around the pipe 18. When the pipe 18 is moved toward the body panel 8, the tension of the hollow sealing leg opening 38 on the pipe 18 may begin to pull the hollow sealing leg 24 into the inverted position. As the pipe 18 is further pulled, the hollow sealing leg 24 may be drawn into the cavity 44 of the grommet 14 as shown in FIG. 5b. Alternatively, the hollow sealing leg 24 may be inverted before inserting the pipe 18. In the inverted position, the sealing rib 70 may contact the conduit 18 to provide a seal.

In operation, it may be possible that the sealing rib 70 does not securely hold the hollow sealing leg 14 in place. The effect of the sealing rib 70 slipping is that the hollow sealing leg 24 may over time move to the extended position as shown in FIG. 5a and thereby lose its sealing effectiveness. In order to prevent the hollow sealing leg 24 from slipping from the inverted position, a ridge of material 72 may be added to the pipe 18 to prevent the sealing rib 70 from moving along the pipe 18. The retention mechanism may be a ridge of material 72 built or secured onto the conduit 18. The material 72 may be a removable one such as one or more layers of tape. The ridge of material 72 may also be formed as part of the pipe 18 itself. The amount of material used may be enough so that the sealing rib 70 cannot easily pass over the ridge of material 72.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a floor including a floor pan and a reinforcement panel spaced away from the floor pan;
at least one mounting post attached to the reinforcement panel;
a cooling line;
a mounting bracket defining an opening and including a recessed portion defining at least one slotted aperture configured to receive the at least one mounting post; and
a grommet extending through the opening and including a sealing ring sealed against the floor pan and a hollow sealing leg having an extended position in which the hollow sealing leg extends away from the grommet and an inverted position in which the hollow sealing leg is disposed within the grommet, wherein the hollow sealing leg is in the inverted position, surrounds the cooling line, and seals against the cooling line when the cooling line extends through the floor pan and the reinforcement panel.

2. The vehicle of claim 1 wherein the floor pan includes a surface facing the reinforcement panel and wherein the sealing ring is sealed against the surface.

3. The vehicle of claim 1 wherein the hollow sealing leg includes a sealing rib that contacts the cooling line when the hollow sealing leg is in the inverted position.

4. The vehicle of claim 1 wherein the cooling line includes a ridge configured to prevent the hollow sealing leg from moving from the inverted position to the extended position.

5. A vehicle comprising:
a floor pan at least partially defining an exterior of the vehicle;
a reinforcement panel spaced away from the floor pan and at least partially defining an interior of the vehicle;
at least one mounting post attached to the reinforcement panel; and
a grommet assembly including (i) a mounting bracket defining an opening and at least one aperture configured to receive the mounting post, wherein the mounting bracket includes a recessed portion defining the at least one aperture, (ii) a grommet extending through the opening, attached to the mounting bracket, and including a sealing ring sealed against the floor pan, and (iii) a hollow sealing leg having an extended position in which the hollow sealing leg extends away from the grommet toward the interior of the vehicle and an inverted position in which the hollow sealing leg is disposed within the grommet and extends toward the exterior of the vehicle.

6. The vehicle of claim 5 wherein the hollow sealing leg includes a sealing rib disposed on an outside of the hollow sealing leg when the hollow sealing leg is in the extended position and disposed on an inside of the hollow sealing leg when the hollow sealing leg is in the inverted position.

7. The vehicle of claim 5 wherein at least one of the apertures is slotted.

8. A vehicle comprising a floor including a floor pan and a reinforcement panel spaced away from the floor pan, at least one mounting post attached to the reinforcement panel, a grommet sealed against the floor pan, and a mounting bracket attached to the reinforcement panel that defines an opening for attaching the grommet and includes a recessed portion defining at least one slotted aperture configured to receive the mounting post.

9. The vehicle of claim 8 wherein the floor pan includes a surface facing the reinforcement panel and wherein the grommet is sealed against the surface.

10. The vehicle of claim 8 wherein the grommet further comprises a hollow sealing leg having an extended position in which the hollow sealing leg extends away from the grommet and an inverted position in which the hollow sealing leg is disposed within the grommet, wherein the hollow sealing leg is in the inverted position, surrounds a cooling line, and seals against the cooling line when the cooling line extends through the floor pan and the reinforcement panel.

11. The vehicle of claim 10 wherein the hollow sealing leg includes a sealing rib that contacts the cooling line when the hollow sealing leg is in the inverted position.
